(19) United States
(12) Patent Application Publication
(10) Pub. No.: US 2014/0241807 A1
(43) Pub. Date: Aug. 28, 2014

(54) PLOUGH VEHICLE ASSEMBLY

(71) Applicant: Murphy Pipe & Civil IP Pty Ltd, Queensland (AU)

(72) Inventors: James Francis Darcy, Queensland (AU); James Timothy O'Connor, Avon by the Sea, NJ (US)

(21) Appl. No.: 14/192,922

(22) Filed: Feb. 28, 2014

(30) Foreign Application Priority Data
Feb. 28, 2013 (AU) 2013900739

(51) Int. Cl. F16L 1/032; F16L 1/06

(52) U.S. Cl. CPC F16L 1/032; F16L 1/065
USPC 405/154.1

(57) ABSTRACT

A plough vehicle assembly is described. The plough vehicle assembly may be able to lay pipe or cable, and include a plough vehicle and a support mounted to the plough vehicle to support a pipe to be laid. The support may include a ring.

### FIELD OF THE INVENTION

This invention relates to a plough vehicle assembly that forms part of a plough system. In particular, the invention relates to a support for supporting pipe to be laid by the plough vehicle

### BACKGROUND OF THE INVENTION

The advantages provided by underground pipes are well recognized by people in the various industries, such as telecommunication, oil, water and gas. However, the laying of underground pipes can be expensive and time consuming. This is especially the case when the terrain provides substantial landscape obstacles such as undulating ground and rivers, in addition, the client requires the pipes to be buried deep into the ground.

The development of the plough system (known in the industry as the “SpiderPlow, Foeck Plough or Spider Plough”) has revolutionized the laying methodologies of underground pipe. The plough system consists of a winch pulling vehicle which is attached via a cable to a plough vehicle. In order to lay pipe using the plough system, pipes are first strung and welded in a continuous line adjacent to where the pipe is to be laid. The starting end of the pipe is then loaded into a pipe laying chute, which forms part of the plough vehicle, using an excavator.

To commence laying the pipe within the ground, the winch vehicle is driven ahead of the plough vehicle. A hydraulic anchor, forming part of the winch vehicle, is then anchored into the ground. A winch, located on the winch vehicle, is then operated to wind in the cable to move forward the plough vehicle. Movement of the plough vehicle causes a ripper, attached to the plough vehicle, to form a trench in the ground. The ripper is located in front of the chute which allows the chute to travel safely through the trench. Pipe fed through the chute is thus laid within the trench. An excavator often trails the plough vehicle to cover the trench if necessary to complete this pipe laying procedure.

There is often great difficulty in loading the chute with a pipe. As mentioned above, a pipe is normally loaded into the chute using an excavator with a special pipe grab. This is not a simple task as pipes are typically large and heavy. Further, the pipes must be bent into a loop and held vertically in order to enable the pipes to be loaded within the chute disclosed in Australian Patent Application No. 2010224386. If the pipe slips from the chute during loading, which can happen easily using a standard excavator bucket, then the tension created in the pipe can cause the pipe to hurtle into the ground with great force. This can cause injury or death to any unfortunate workers who are struck by the pipe.

Further, as great care is needed when looping the pipe, loading the chute with the pipe is very time consuming. If too much force is applied to the pipe when the pipe is looped then the pipe may become damaged, kink or even break.

When the plough vehicle is installing pipe into the ground, any weakness in the pipe can cause the pipe to kink when the pipe travels through the loop. A kink in a pipe is a major issue and stops the laying of pipe. In order to rectify the kink in the pipe, the kinked section of pipe must be cut out of the loop. The pipe ends must then be welded together and the loop reformed. This is very difficult, time consuming and costly process.

The reference to any prior art in this specification is not, and should not be taken as, an acknowledgement or any form of suggestion that the prior art forms part of the common general knowledge.

### OBJECT OF THE INVENTION

It is an object of the invention to overcome and/or alleviate one or more of the above disadvantages and/or provide the consumer with a useful or commercial choice.

### SUMMARY OF THE INVENTION

In one form, although not necessarily the only or broadest form, the invention resides a plough vehicle assembly that is able to lay pipe or cable, the pipe vehicle system comprising:

a plough vehicle; and

a support mounted to the plough vehicle to support a pipe to be laid;

wherein the support includes a ring.

The plough vehicle normally includes a body which has at least two articulated legs. Preferably, the plough vehicle has four articulated legs that are connected to the body.

Each leg normally has at least one wheel attached to an articulated leg. Preferably, there is a single wheel associated with a single leg.

The plough vehicle typically includes a pipe laying chute. The chute is normally mounted to the body. The chute is normally S-shaped.

The chute may include an upper portion and a lower portion Normally, the lower portion is pivotally connected to the upper portion. A pivot pin may be used to pivotally connect the upper portion to the lower portion.

The chute typically includes at least one channel that extends through both the upper portion and the lower portion. The chute may include an undivided channel to lay a single pipe or a divided channel to lay two pipes.

When there is a divided channel, the divided channel of the upper portion is designed so that the pipes enter the divided channel in a substantially vertical alignment with each other whilst the lower portion is designed the divided channel of the lower portion so that the pipes exit the divided channel so that the pipes are in a substantially horizontal alignment.

A movement mechanism may be used to move the upper portion with respect to the lower portion. Normally, the movement mechanism is in the form of a hydraulic ram. The hydraulic ram may be pivotally attached to the upper portion and/or the lower portion. It should appreciated that other types of movement mechanisms may be used, such as powered gears, motors or the like.

A locking mechanism may be used to lock the upper portion with respect to the lower portion. Typically, the upper portion is locked when it is in a feeding position. The upper portion may be locked to the lower portion. A locking pin may extend through the upper portion and the lower portion to lock the upper portion to the lower portion.

An entrance to the upper portion of the chute may be flared. A length of the upper portion may be substantially shorter than the length of the lower portion.

A bend radius of the upper portion is normally substantially the same as a bend radius of the lower portion.

A bend radius the lower portion of the chute may be at least 6.5 meters. Preferably the bend radius of the lower portion is between 6.5 and 9 meters. More preferably bend radius of the lower portion is between 6.5 and 7.5 meters. Still more preferably bend radius of the lower portion is between 6.75 and 7.25 meters.

The ring may be movable between an open position in which the pipe can be located within the ring and a closed position which is used when the pipe is laid. Accordingly, the ring may include a base and a top, the top being movable with respect to the base. The top may be pivotally movable with respect to the base. The top may be moved using an actuating device to move the top with respect to the base. Normally, the actuating device is in the form of a hydraulic ram. It should be appreciated that other types of actuating devices may be used, such as powered gears, motors or the like.

The ring is typically rectangular in shape. However, the ring may be other shapes.

Normally the base is substantially U-shaped. That is the base may include two uprights members that are joined by an interconnecting member.

The top interconnect the two uprights. The top may substantially the same length as the interconnecting member.

Internal faces of the ring may be shaped so that there are no point loads on the pipe. Accordingly, the internal faces of the ring may be curved.

The support may also include a mount. The mount may be used to mount the ring. The mount may be attached to the base of the ring.

Preferably the mount includes a series of frame members. Normally the one or more frame members are mounted to the body of the plough vehicle.

The mount may be movable with respect to the plough vehicle. One or more of the frame member may be movable with respect to the plough vehicle. One or more of the frame members may be pivotally mounted to the plough vehicle.

A driver may form part of the mount to move the frame members between a support position and a travel position. The driver may be in the form of one or more hydraulic rams. It should appreciated that other types of drivers may be used, such as powered gears, motors or the like.

In another form, the invention resides in a method of operating a plough vehicle that is able to lay pipe or cable, the method including the steps of:

locating a pipe into a ring of a support that is mounted on a plough vehicle.

The invention may further include one or more of the steps of:

opening a top of the ring to allow the pipe to be located within the ring of the support;

closing a top of the ring to enclose the pipe within the ring of the support;

locating a pipe into an upper portion of a chute which is attached to a plough;

moving the upper portion of the chute from a feeding position to a transport position; and

moving a mount of the support from a support position and a travel position.

In another form, the invention resides in a method of operating a plough vehicle that is able to lay pipe or cable, the method including the steps of:

moving a mount of the support from a support position and a travel position.

In yet another form, the invention resides in a plough vehicle assembly that is able to lay pipe or cable, the pipe vehicle system comprising:

a plough vehicle; and

a support mounted to the plough vehicle to support a pipe to be laid; the support including a guide attached to a mount

wherein the mount is moveable between a support position and a mount position.

The guide is typically in the form of a ring.

In yet another form, the invention resides in a chute for a plough vehicle, the chute comprising:

an upper portion connected to a lower portion

wherein the lower portion has a bend radius of greater than 6.5 meters.

In still yet another form, the invention resides in a chute for a plough vehicle, comprising:

an upper portion connected to a lower portion;

wherein the upper portion is curved in one direction whilst the lower portion is curved in an opposite direction.

Further forms and features of the present invention will become apparent from the following detailed description.

### BRIEF DESCRIPTION OF THE DRAWINGS

An embodiment, by way of example only, will now be described with reference to the accompanying drawings in which:

FIG. 1 is a perspective view of a plough vehicle assembly in normal use with the ring in a closed position, the mount in a support position and the chute in a feeding position;

FIG. 2 is a side view of a plough vehicle assembly being loaded with the ring in a open position and the chute in a feeding position;

FIG. 3A is a top view of a plough vehicle assembly in normal use with the ring in a closed position and the chute in a feeding position;

FIG. 3B is a side view of a plough vehicle assembly in normal use with the ring in a closed position and the chute in a feeding position;

FIG. 4 is a side view of a plough vehicle assembly coming to an end of a pipe with the ring in a closed position and the chute in a feeding position;

FIG. 5 is a perspective view of a plough vehicle assembly read for transport with the ring in a closed position, the mount in a travel position and the chute in a feeding position.

FIG. 6 is a side view of a plough vehicle assembly in normal use in which two pipes are being ploughed;

FIG. 7 is a top view of a plough vehicle assembly in normal use in which two pipes are being ploughed;

FIG. 8 is top view of a chute used to plough two pipes as shown in FIGS. 6 and 7;

FIG. 9 is side sectional view of a chute used to plough two pipes as shown in FIGS. 6 and 7;

FIG. 10 is front view of a chute used to plough two pipes as shown in FIGS. 6 and 7;

FIG. 11 is perspective view of a chute used to plough two pipes as shown in FIGS. 6 and 7;

FIG. 12 is sectional perspective view of a chute used to plough two pipes as shown in FIGS. 6 and 7; and

FIG. 13 is further sectional perspective view of a chute used to plough two pipes as shown in FIGS. 6 and 7;

### DETAILED DESCRIPTION OF THE PREFERRED EMBODIMENT

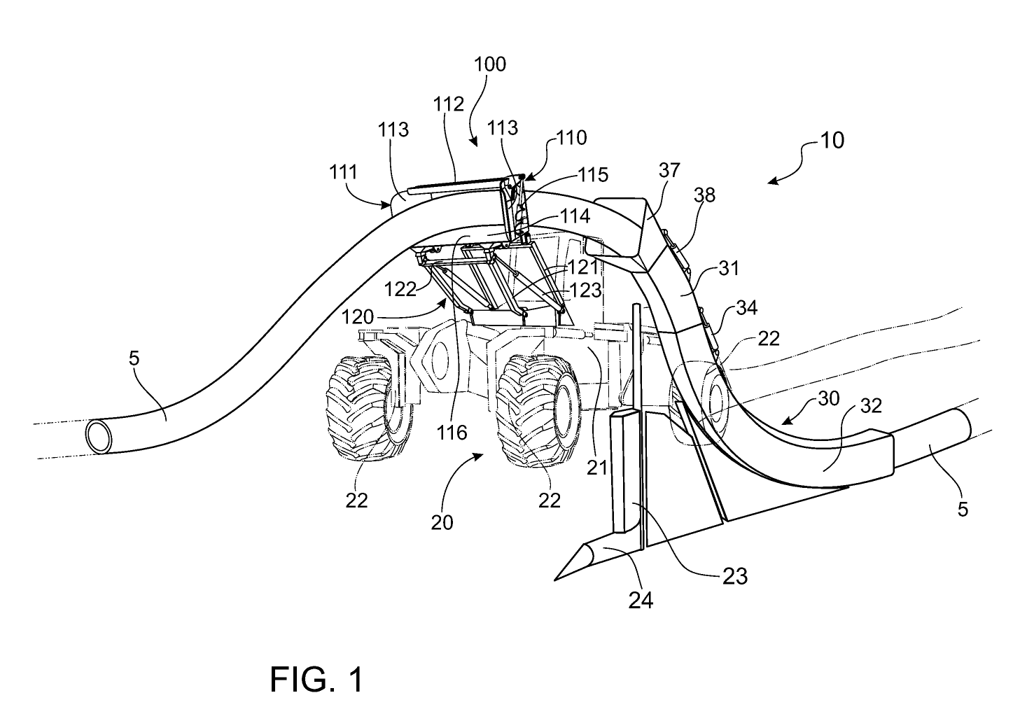

FIG. 1 shows a plough vehicle assembly 10 being used to lay a pipe 5. The plough vehicle assembly 10 includes a plough vehicle 20 and a support 100.

The plough vehicle 20 is located behind a winch vehicle (not shown) and is used to plough pipes 5 (or cables) into the ground. The plough vehicle 20 has a cabin body 21 which is supported by four articulated legs 22. A sword 23 extends downwardly from the cabin body 31. A ripper 24 is located at the end of the sword 23. A chute 30 is located behind the sword 23 and ripper 24.

The chute 30 is made from metal and is hollow. That is, a channel extends through the chute 30. The chute 30 is formed from an upper portion 31 and a lower portion 32. The upper portion 31 is pivotally connected to the lower portion 32 via a pivot pin. A hydraulic ram 34 extends between and is pivotally connected to both the upper portion 31 and the lower portion 32. A locking pin aperture (not shown) extends through the upper portion 31 and the lower portion 32. A locking pin (not shown) is located within the locking pin aperture to lock the upper portion 31 to the lower portion 32.

A fared entrance portion 37 is attached to an end of the upper portion 31. The flared portion 37 is able to be pivoted with respect to the upper portion 37. A hydraulic ram 38 extends between and is pivotally connected to both the upper portion 31 and the flared portion 27.

The chute 30 is substantially S-shape with the upper portion 31 being curved in one direction whilst the lower portion 32 is curved in an opposite direction. The upper portion 31 has a bend radius that is substantially the same as the bend radius of the lower portion 32. The bend radius of the lower portion 32 is approximately 7 meters. Similarly, the length of the upper portion 31 is substantially less than the length of the lower portion. It should be appreciated that the diameters of the upper portion 31 and the lower portion 32 and the lengths of the upper portion and lower portion may be varied depending on the size of the pipe being laid.

The support 100 is formed from ring 110 and a mount 120. The ring 110 is substantially rectangular in shape. The ring 110 is formed from a base 111 and a top 112. The base 111 is formed from two uprights 113 and an interconnecting member 114. The top 112 is pivotally connected to the base 111 via one of the uprights. The top 112 is connected to and moved by a hydraulic ram 115. The hydraulic ram 115 moves the top 112 between an open position in which the top 115 allows the pipe to be placed within the ring 110 and a closed position that holds the pipe within the ring 110. When the top 112 is in the closed position, the top 112 extends between the uprights of the base 112. The internal faces 116 of the uprights 113, interconnecting member 114 and top 112 are curved.

The mount 120 is formed using a series of frame members 121. The frame members 121 are pivotally connected to the cabin body 21 of the plough vehicle. The frame members are also pivotally attached to the ring 110. Accordingly, the frame members 121 form a parallelogram linkage. Cross members 122, located adjacent the ring 110, extend between frame members 121. Two hydraulic rams 123 are connected to respective frame members to move the mount between a support position in which the ring 110 is located above a top of the cabin body 121 and a transport position where the ring 110 is located below a top of the cabin body 121.

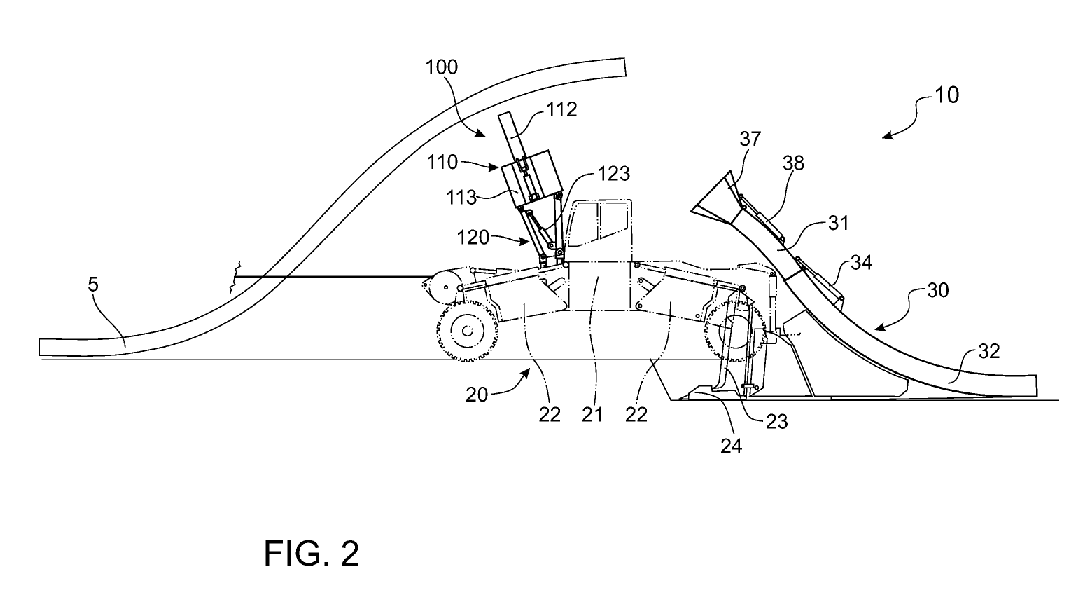

In use, the pipe 5 to be laid is located adjacent to the plough vehicle 20. In order to lay the pipe, the pipe 5 must be located within the support 100. To load the pipe 5 within the support 100, the top 112 of the ring 110 is pivoted upwardly to an open position using the associated hydraulic ram 115 as shown in FIG. 2A. An excavator or the like piece of equipment is than used to pick up the pipe and place the pipe 5 within ring 110. The top 112 is than moved from the open position to a closed position by movement of the associated hydraulic ram 115.

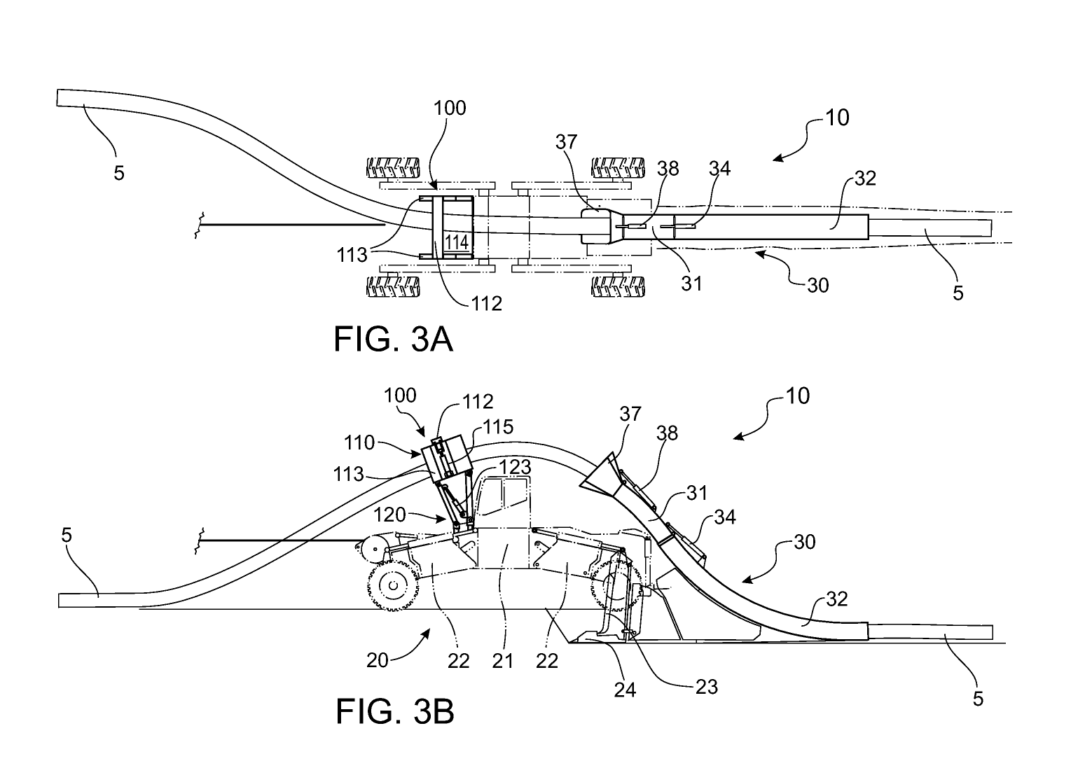

The pipe 5 is then located within the chute 30 by moving plough vehicle 20 forward until the pipe 5 is fed into the flared entrance portion 37 of the chute 30. The plough vehicle 20 is moved forward until the pipe 5 passes through the upper portion 31 and lower portion 32 of the chute 30. The plough vehicle 30 is then able to lay pipe in a normal manner as shown in FIGS. 3A and 3B.

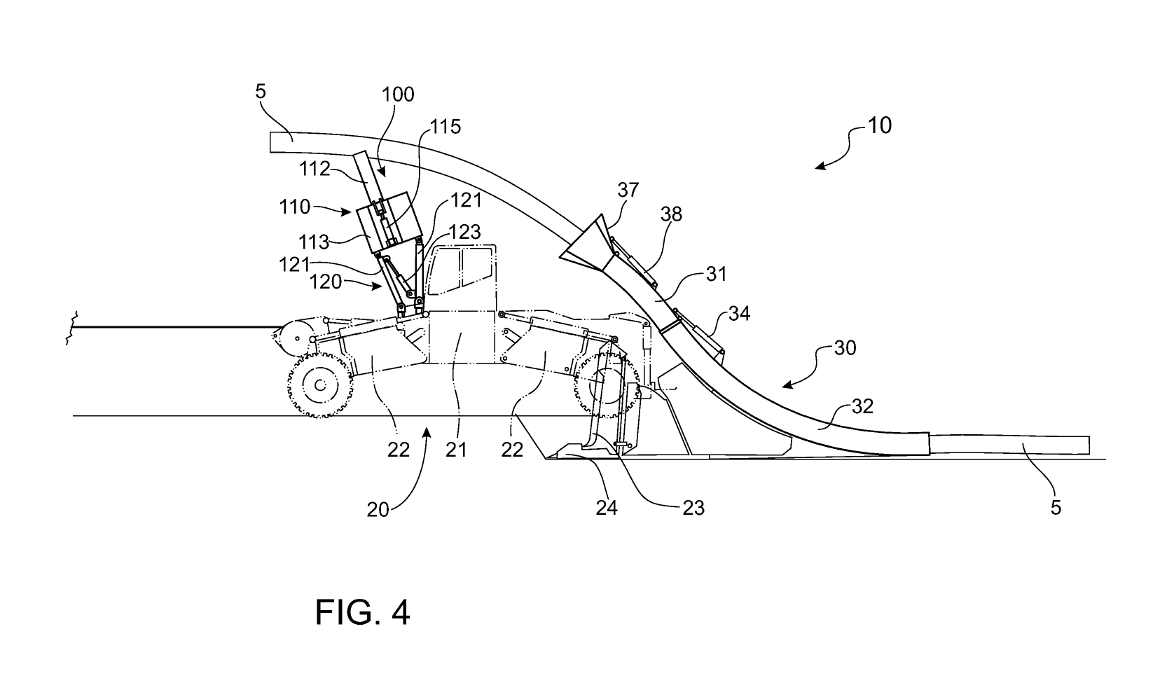

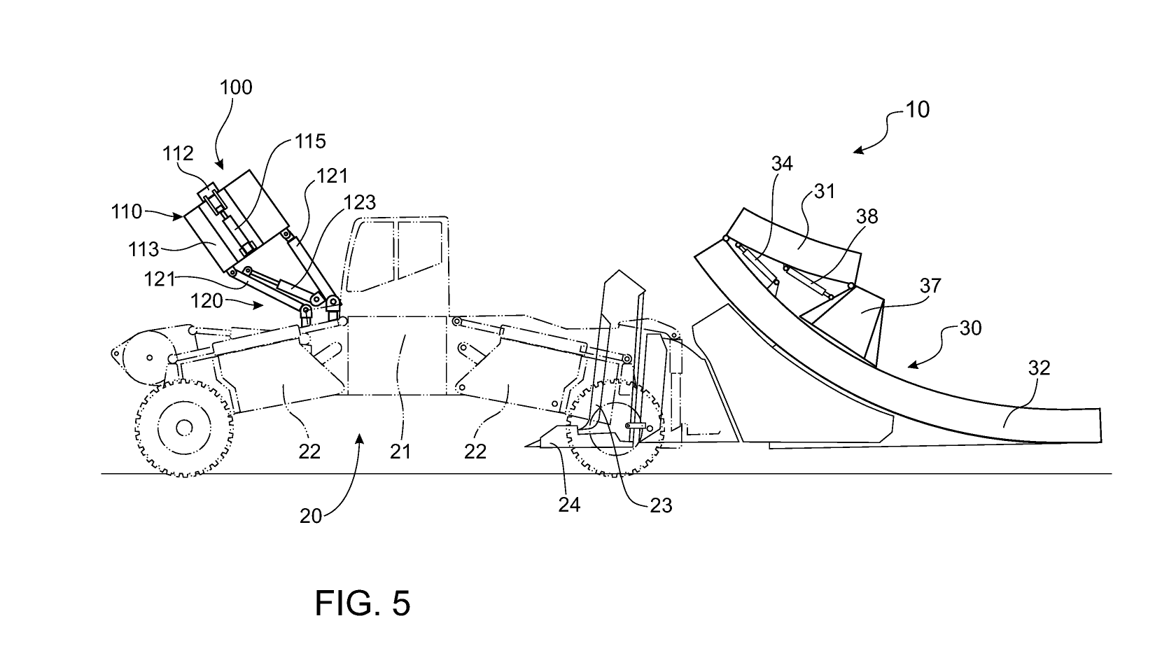

When an end of the pipe 5 being laid lifts off the ground, the top 112 of the ring 110 is moved from a closed position to an open position. As the pipe 5 travels through the ring 110, the inherent rigidity of the pipe 5 will cause the pipe 5 to travel adjacent the top 112 of the ring 110 whilst the pipe 5 is supported on the base 111 as shown in FIG. 4A. By moving the top 112 to an open position when the end of the pipe 4 passes through the ring 110, this prevents the end of the pipe 4 from being flung upward uncontrollably which would occur if the top 112 was left in a closed position. Instead, the pipe 4 flows in a controlled motion steadily through the chute 30 without any danger of the pipe 5 being flung uncontrollably.

In order to transport the plough vehicle 20 from one plough site to another, the plough vehicle 20 typically is located on a transport vehicle. Height restrictions are often an issue when transporting the plough vehicle 20. Accordingly, when the plough vehicle 20 is to be transported, the support must be lowered from a support position in which the ring 110 is located above a top of the cabin body 21 to a transport position where the ring 110 is located below the top of the cabin body 21. The lowering of the ring 110 involves pivoting the associated frame members 121 using the associated hydraulic rams 123. Further, the chute 30 must be moved from a feeding position to a transport position. This involves rotating the upper portion 31 of the chute 30 with respect to the lower portion 32 of the chute 30 using the associated hydraulic ram and rotating the flared entrance portion 37 of the chute 30 with respect to the upper portion 31 of the chute 30. This allows easy transportation of the plough vehicle 20.

The plough vehicle assembly enables pipe of relatively large diameters (e.g. 450 millimeters) to be laid quickly and effectively. The pipe can be quickly loaded and safety held within the support 100. The internal faces of the ring 110 are curved so that there are no sharp surfaces that will damage the pipe during laying. The support 100 can also be varied in height to quickly and easily transport the vehicle safety from one located to another. Further, the pipe can be located within the chute 30 quickly and easily and the chute 30 can be split to make transportation easier.

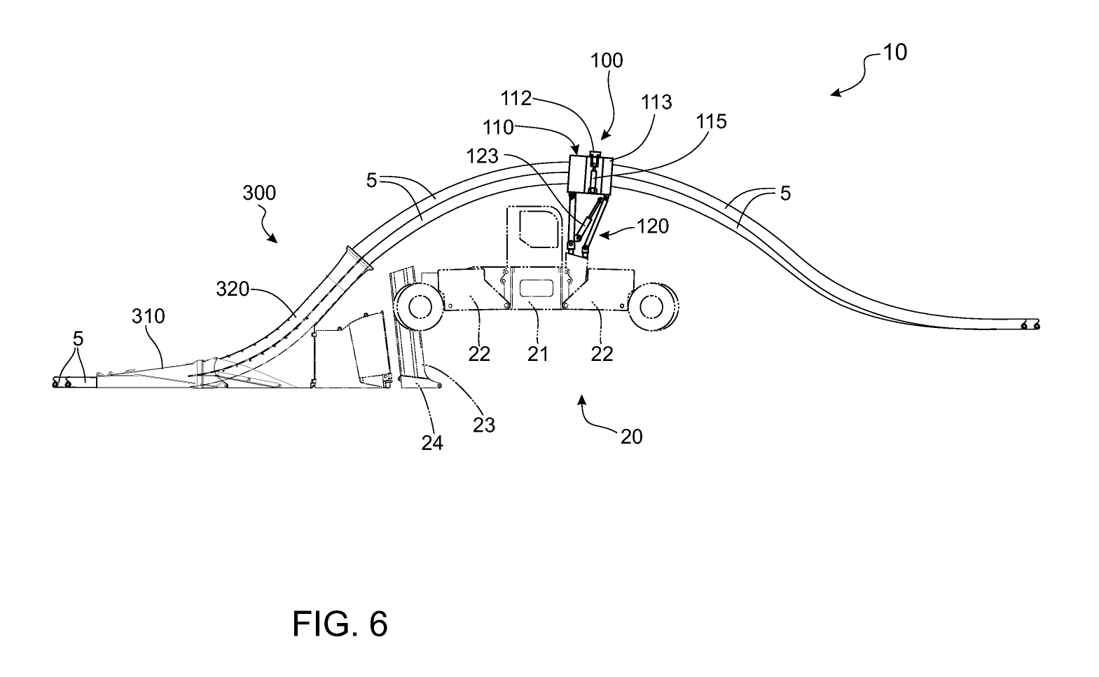

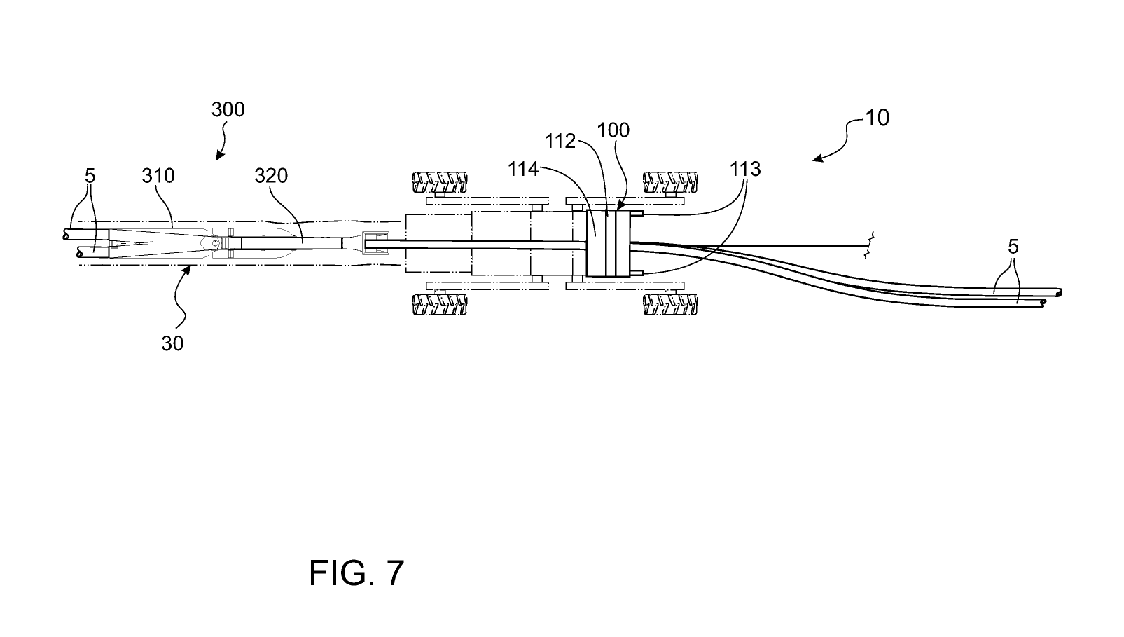

FIGS. 6 and 7 show a variation of the plough vehicle assembly shown in FIG. 1. Like numerals have been used to describe like components. In this embodiment the only variation that has been made is to the chute 300. In this embodiment, the chute 300 is able to be used to lay two pipes simultaneously.

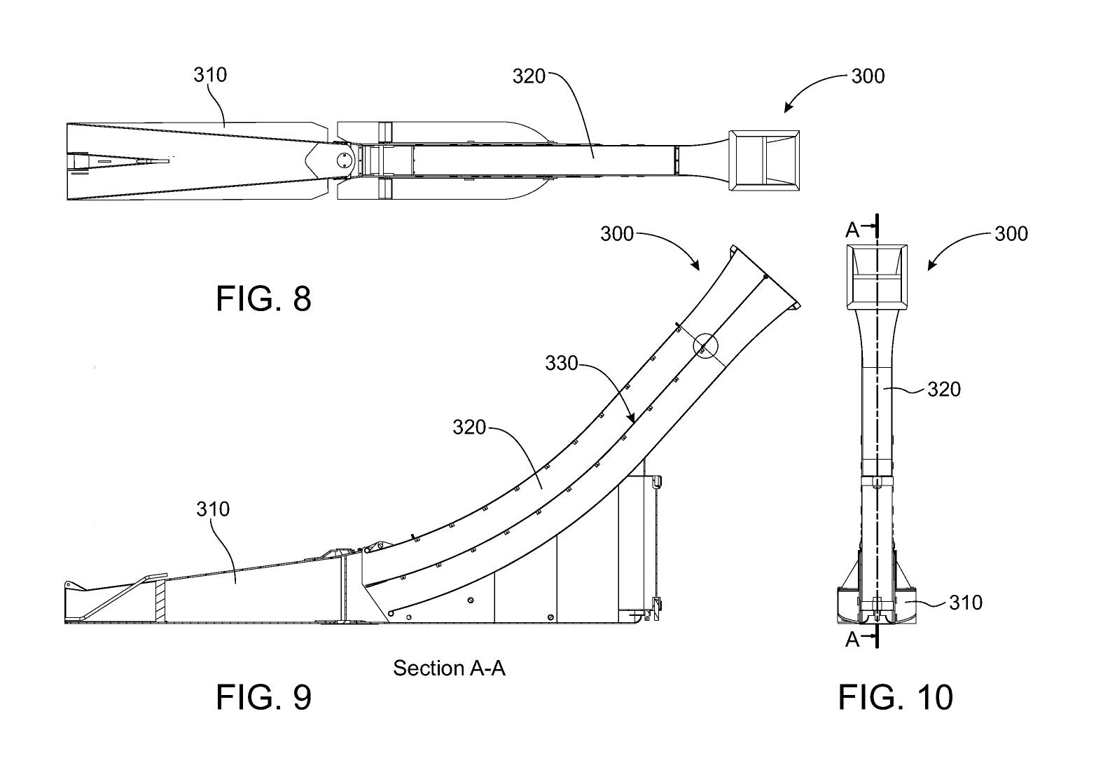

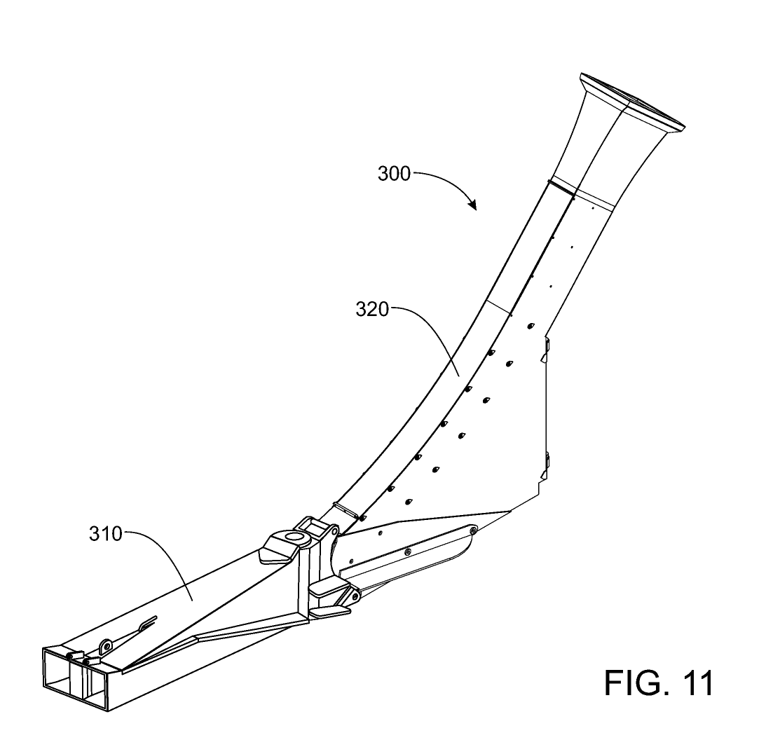

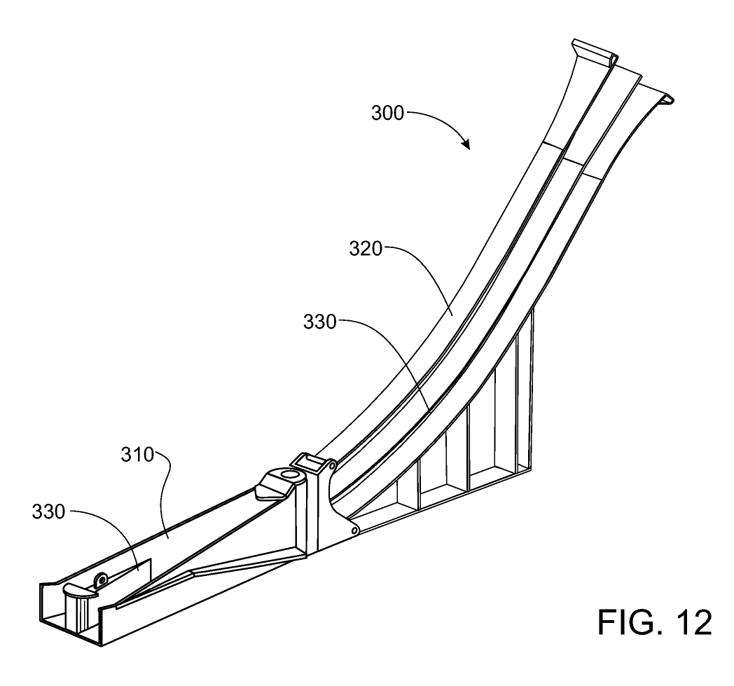

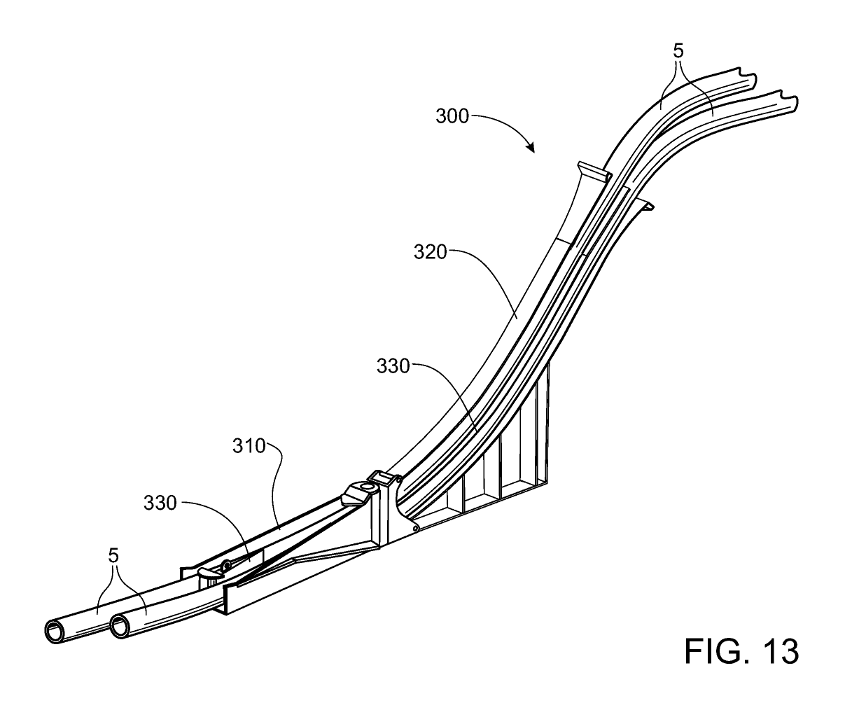

The chute 300, shown in more detail in FIGS. 8 to 13, show is substantially S-shape with the upper portion 310 being curved in one direction whilst the lower portion 320 is curved in an opposite direction. A channel 330 extends through the chute 330. The channel 330 is divided into two along the length of the upper portion 320. The channel 330 is also divided into two toward the end of the lower portion 310. The divided channel 330 of the upper portion 310 is designed so that the pipes 5 enter the divided channel in a substantially vertical alignment with each other whilst the lower portion 320 is designed the divided channel 5 of the lower portion so that the pipes 5 exit the divided channel 5 so that the pipes are in a substantially horizontal alignment.

The upper portion 310 has a bend radius that is substantially the same as the bend radius of the lower portion 320. The bend radius of the lower portion 320 is approximately 7 meters (is this correct?). Similarly, the length of the upper portion 310 is substantially less than the length of the lower portion. It should be appreciated that the diameters of the upper portion 310 and the lower portion 320 and the lengths of the upper portion and lower portion may be varied depending on the size of the pipe being laid.

In use, the pipes 5 are loaded in the same manner as described above with the exception there are two pipes 5 which must be placed within chute 300. Otherwise the operation of the plough vehicle assembly 10 is as described in the first embodiment.

In this specification, the terms “comprise”, “comprises”, “comprising” or similar terms are intended to mean a non-exclusive inclusion, such that a system, method or apparatus that comprises a list of elements does not include those elements solely, but may well include other elements not listed.

It should be appreciated that various other changes modifications may be made to the embodiment described with that departed from the spiritual scope of the invention.

What is claimed is:

1. A plough vehicle assembly that is able to lay pipe or cable, the plough vehicle assembly comprising:
a plough vehicle; and
a support mounted to the plough vehicle to support a pipe to be laid;
wherein the support includes a ring.

2. The plough vehicle assembly of claim 1 wherein the plough vehicle includes a body which has at least two articulated legs.

3. The plough vehicle assembly of claim 2 wherein the plough vehicle has four articulated legs that are connected to the body.

4. The plough vehicle assembly of claim 2 wherein at least one wheel is attached to the at least two articulated legs.

5. The plough vehicle assembly of claim 2 wherein there is a single wheel associated with one of the two articulated legs.

6. The plough vehicle assembly of claim 1 wherein the plough vehicle includes a pipe laying chute.

7. The plough vehicle assembly of claim 6 wherein the chute is mounted to a body.

8. The plough vehicle assembly of claim 6 wherein the pipe laying chute is S-shaped.

9. The plough vehicle assembly of claim 6 wherein the pipe laying chute includes an upper portion and a lower portion.

10. The plough vehicle assembly of claim 9 wherein the lower portion is pivotally connected to the upper portion.

11. The plough vehicle assembly of claim 10 wherein a pivot pin is used to pivotally connect the upper portion to the lower portion.

12. The plough vehicle assembly of claim 9 wherein the pipe laying chute includes at least one channel that extends through both the upper portion and the lower portion.

13. The plough vehicle assembly of claim 12 wherein the pipe laying chute includes an undivided channel.

14. The plough vehicle assembly of claim 12 wherein the pipe laying chute includes a divided channel.

15. The plough vehicle assembly of claim 14 wherein the divided channel of the upper portion is designed so that the pipes enter the divided channel in a substantially vertical alignment with each other whilst the lower portion is designed the divided channel of the lower portion so that the pipes exit the divided channel so that the pipes are in a substantially horizontal alignment.

16. The plough vehicle assembly of claim 9 wherein a movement mechanism is used to move the upper portion with respect to the lower portion.

17. The plough vehicle assembly of claim 16 wherein the movement mechanism is in the form of a hydraulic ram.

18. The plough vehicle assembly of claim 17 wherein the hydraulic ram is pivotally attached to the upper portion and/or the lower portion.

19. The plough vehicle assembly of claim 9 wherein a locking mechanism a used to lock the upper portion with respect to the lower portion.

20. The plough vehicle assembly of claim 19 wherein the upper portion is locked when it is in a feeding position.

21. The plough vehicle assembly of claim 19 wherein a locking pin extends through the upper portion and the lower portion to lock the upper portion to the lower portion.

22. The plough vehicle assembly of claims 9 wherein an entrance to the upper portion of the pipe laying chute is flared.

23. The plough vehicle assembly of claim 9 wherein a length of the upper portion is substantially shorter than the length of the lower portion.

24. The plough vehicle assembly of claim 9 wherein a bend radius of the upper portion is substantially the same as a bend radius of the lower portion.

25. The plough vehicle assembly of claim 9 wherein a bend radius of the lower portion of the pipe laying chute is at least 6.5 meters.

26. The plough vehicle assembly of claim 9 wherein a bend radius of the lower portion is between 6.5 and 9 meters.

27. The plough vehicle assembly of claim 1 wherein the ring is movable between an open position in which the pipe can be located within the ring and a closed position which is used when the pipe is laid.

28. The plough vehicle assembly of claim 1 wherein the ring includes a base and a top, the top being movable with respect to the base.

29. The plough vehicle assembly of claim 28 wherein the top may be pivotally movable with respect to the base.

30. The plough vehicle assembly of claim 28 wherein the top is moved with respect to the base by using an actuating device.

31. The plough vehicle assembly of claim 1 wherein the ring is rectangular in shape.

32. The plough vehicle assembly of claim 28 wherein the base is substantially U-shaped.

33. The plough vehicle assembly of claim 28 wherein the base includes two uprights members that are joined by an interconnecting member.

34. The plough vehicle assembly of claim 33 wherein the top interconnects the two uprights when the ring is in the closed position.

35. The plough vehicle assembly of claim 1 wherein the internal faces of the ring are shaped so that there are no point loads on the pipe.

36. The plough vehicle assembly of claim 35 wherein the internal faces of the ring are curved.

37. The plough vehicle assembly of claim 1 wherein the support includes a mount.

38. The plough vehicle assembly of claim 37 wherein the mount is used to mount the ring.

39. The plough vehicle assembly of claim 37 wherein the mount is attached to the base of the ring.

40. The plough vehicle assembly of claim 37 wherein the mount includes a series of frame members.

41. The plough vehicle assembly of claim 37 wherein one or more frame members are mounted to the body of the plough vehicle.

42. The plough vehicle assembly of claim 37 wherein the mount is movable with respect to the plough vehicle.

43. The plough vehicle assembly of claim 40 wherein one or more of the frame members is movable with respect to the plough vehicle.

44. The plough vehicle assembly of claim 40 wherein one or more of the frame members is mounted to the plough vehicle.

45. The plough vehicle assembly of claim 40 wherein a driver forms part of the mount to move the frame members between a support position and a travel position.

46. A method of operating a plough vehicle that is able to lay pipe or cable, the method including the step of:
locating a pipe into a ring of a support that is mounted on a plough vehicle.

47. The method of claim 46, further including at least one of the following steps:
opening a top of the ring to allow the pipe to be located within the ring of the support;
closing a top of the ring to enclose the pipe within the ring of the support;
locating a pipe into an upper portion of a chute which is attached to a plough;
moving the upper portion of the chute from a feeding position to a transport position; and
moving a mount of the support from a support position and a travel position.

48. A plough vehicle assembly that is able to lay pipe or cable, the plough vehicle assembly comprising:
a plough vehicle; and
a support mounted to the plough vehicle to support a pipe to be laid; the support including a guide attached to a mount
wherein the mount is moveable between a support position and a mount position.

49. The plough vehicle assembly of claim 48 wherein the guide is in the form of a ring.
